(19) United States
(12) Patent Application Publication
(10) Pub. No.: US 2020/0166401 A1
(43) Pub. Date: May 28, 2020

(54) Method And System For Weighing Payload In A Flying Aircraft

(71) Applicant: Troy Robert Reabe, Duluth, MN (US)

(72) Inventor: Troy Robert Reabe, Duluth, MN (US)

(21) Appl. No.: 16/199,123

(22) Filed: Nov. 23, 2018

(51) Int. Cl. G01G 19/12; G01C 23/00

(52) U.S. Cl. CPC G01G 19/12; G01C 23/005

(57) ABSTRACT

During crop dusting application, there is no accurate method to detect the quantity of dry product onboard. This can lead to improper application rates and waste of product. The dry quantity gauge system solves this problem. The system detects strain on select structures of the aircraft during flight. The system monitors other in-flight aircraft characteristics that induce errors on the payload weight estimation. The software filter changes the influence of collected measurements based on the sensor data. The result is a stable and reliable payload estimate for the pilot at any given time during flight even during product application. Since the pilot will always know the amount of product onboard, it builds pilot's intuition, reduces workload, and ensures a more accurate application for the client. There are no similar systems to date that weigh the aircraft payload in flight.

### REFERENCE TO RELATED APPLICATIONS

This patent application claims the benefit of U.S. Provisional Application No. 62/589,692 filed on Nov. 22, 2017, the disclosure of which is incorporated herein by reference in its entirety.

### BACKGROUND OF THE INVENTION

### 1. Field of the Invention

The present invention relates to measuring and detection systems, and more particularly to a method and system for weighing payload in a flying aircraft.

### 2. Background of the Invention

During crop dusting application, there is no accurate method to detect the quantity of dry product onboard at any given time. This can lead to improper application rates and waste of product. Current methods such as visually monitoring product through the hopper window or detecting the metered output using a rotary dispensing gate are inaccurate and prone to errors.

The method that relies upon pilot's visual observation and intuition is widely variable and unreliable. The method of metered output is theoretically a good option, but in real world application it quickly falls short because differences in density, product clumping, jams, obstructions, or other mechanical failures produce inaccurate dosing rates.

Moreover, a classic crop duster setup does not have a metered output system, so the rate of application is dependent upon the pilot's intuitive estimate of the product weight. Even a highly experienced pilot's intuition lacks the ability to accurately estimate product, especially for more complicated work like splitting a payload into two separate applications, which is often required.

Thus, there exists a need for a method and system that will accurately measure the payload weight in real-time so that the pilot will always know the amount of product onboard, it will reduce the pilot's workload, and ensure a more accurate application for the client.

### SUMMARY OF THE INVENTION

As stated above, during crop dusting application, there is no accurate method to detect the quantity of dry product onboard at any given time. This can lead to improper application rates and waste of product. Current methods such as visually monitoring product through the hopper window or detecting the metered output using a rotary dispensing gate are inaccurate and prone to errors. The invention claimed here solves those sources of error and differs from what currently exists.

In one aspect of the present invention, disclosed herein is a system for weighing payload in real-time in a flying aircraft.

In an exemplary embodiment of the present invention, there is disclosed a system for weighing payload in real-time in a flying aircraft, which includes: a strain gauge mounted on the upper spar cap of the aircraft structure to detect a strain signal; a first strain gauge amplifier to magnify the strain gauge reading; an accelerometer mounted near the aircraft's center of gravity with axis aligned to the aircraft axis; a set of filtering electronics, analog or digit to remove noise and the g-load contribution from the spar load input and accelerometer; a set of converter electronics connected to the filtering electronics to map or convert the filtered amplified strain into a weight reading; and a readout display device for showing the pilot the calculated payload in the hopper. In an exemplary embodiment of the present invention, the system may further include one or more of the following components: a strain gauge mounted on a horizontal stabilizer bracer; a strain gauge amplifier connected to the second strain gauge to magnify the strain signal resulting in a horizontal stabilizer load input which is a reading of the downward force the tail is providing to the plane; a component to determine flap position input; a component to determine fuel quantity input; a component to determine dump gate position input; and a component to determine angle of attack input; and a weighted input filtering electronics which adjusts filtering values based on the multiple inputs to produce the hopper weight.

In one aspect of the present invention, disclosed herein is a method for weighing payload in real-time in a flying aircraft.

In an exemplary embodiment of the present invention, there is disclosed a method for weighing payload in real-time in a flying aircraft, which includes the steps of: mounting a strain gauge on the top of the upper spar cap of the aircraft such that the strain gauge's axis is aligned to the axis of the spar and connecting the first strain gauge to a first strain gauge amplifier using lead wires to provide a spar load input; mounting an accelerometer near the main wing spar at the center of the aircraft such that the axes of the accelerometer are square to the axes of the aircraft to provide an accelerometer input; mounting a set of weighted input filtering electronics; mounting a readout display in the cockpit in clear view of the pilot; and mounting remaining electronics; running test flights with the aircraft at 3 or more known payload weights; calibrating the strain gauge to correlate to a payload weight; collecting data and putting data into filter; wherein the remaining electronics including a set of filtering electronics that receives the spar load input; a set of converter electronics that is connected to the filtering electronics; wherein the filtering electronics is analog or digital filters that remove noise and g-load contribution from the spar load input to generate filtered spar load input, the converter electronics map or convert the filtered amplified strain into a weight reading; and the weighted input filtering electronics adjust filtering values based on multiple inputs to produce the hopper weight; wherein the spar load input and accelerometer input are transferred through the set of filtering electronics where they are combined and sent to the converter electronics where the filtered spar load input is converted into a weight reading data.

In an exemplary embodiment of the present invention, the method further comprises one or more of the following steps: mounting a second strain gauge on the horizontal stabilizer brace structure such that the strain gauge's axis is aligned to the axis of the horizontal brace and connecting the second strain gauge with a second strain gauge amplifier with lead wires for providing horizontal force (horizontal stabilizer load input); mounting a flap position input sensor next to the flap actuator for providing flap position input; connecting fuel quantity input onto the aircrafts fuel gauges in cockpit for providing fuel quantity input; mounting a dump gate position input sensor on the over center bell crank down at the dump gate for providing dump gate position input; mounting an angle of attack input sensor on the wing for providing angle of attack input.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 illustrates a crop duster airplane having a system for weighing payload to an exemplary embodiment of the present invention; and

FIG. 2 is an expanded (exploded) view of strain gauge(s) installed on a selected structure for purposes of detecting payload weight to get maximum readout variation with different hopper payloads.

FIG. 3 illustrates a diagram showing how the method and system works.

### DETAILED DESCRIPTION OF THE INVENTION

As stated above, during crop dusting application, there is no accurate method to detect the quantity of dry product onboard at any given time. This can lead to improper application rates and waste of product. Current methods such as visually monitoring product through the hopper window or detecting the metered output using a rotary dispensing gate are inaccurate and prone to errors.

The method that relies upon pilot intuition is widely variable and unreliable. The method using a rotary dispensing gate where the pilot deduces a weight estimate based on the initial payload and the inaccurate metered output is also unreliable. The metered output system doesn't work well because it does not account for differences in density, product clumping, jams, obstructions, or mechanical failures. Problems occur very regularly with these factors. When it does occur, the pilot doesn't immediately realize it until a noticeably incorrect amount of product is onboard. This means that an incorrect amount of product was dispensed during application. More importantly, since the pilot does not know when the problem started, the incorrect product output during application cannot be fixed. Both methods are prone to errors by irregularities in the product. The invention claimed here solves those sources of error and differs from what currently exists. There are no similar systems to date that weigh the aircraft payload in flight.

The dry quantity gauge system detects strain on select structures, such as the spar, of the aircraft during flight. The system also monitors characteristics of the aircraft that can induce errors on the payload weight estimation while accelerometers account for the g-load variations. The software filter will change the influence of these collected measurements based on the readings from the sensors. The results are a stable and reliable payload estimate for the pilot at any given time during flight even during product application. Since the pilot will always know the amount of product onboard, it will build the pilot's intuition, reduce the workload, and ensure a more accurate application for the client.

In one aspect, disclosed herein is a system for weighing payload in a flying aircraft.

According to some embodiments, the system for weighing payload in a flying crop duster aircraft 1 is comprised of the following components:

A crop duster airplane 1 which is an aircraft that has been built or converted for agricultural use of dispensing dry product;

An aircraft payload hopper 2 which contains a product and is the storage tank for holding the dry product;

A selected structure 3 which is selected to monitor strain for purposes of detecting payload weight;

A strain gauge 4 which is a quarter half or full strain gauge mounted on aircraft structure in appropriate direction to get maximum readout variation with different hopper payloads;

A strain gauge amplifier circuit 5 which magnifies the strain gauge reading to be transmitted to the other electronics in the system;

An accelerometer 6 which is mounted with axis aligned to the aircraft axis and mounted close to the GC of the aircraft, so the dynamics of flight do not influence its readings;

Filtering electronics 7 which is analog or digital filters that remove noise from measurements to calculate weight;

Converter electronics 8 which maps or converts the filtered amplified strain into a weight reading;

Weighted input filtering electronics 9 which adjusts filtering values based on multiple inputs to produce the hopper weight;

Flap position input 10 which is a continuous or binary reading that could be derived from something like a potentiometer or micro switch to give flap position;

Fuel quantity input 11 which is a reading of the quantity of fuel onboard;

Dump gate position input 12 which is a continuous or binary reading that could be derived from something like a potentiometer or micro switch to give dump gate position;

Angle of attack input 13 which is a reading of the angle of attack of the flying plane;

Horizontal stabilizer load input 14 which is a reading of the downward force the tail is providing to the plane;

Readout display 15 which is a device to show the pilot the calculated payload in the hopper in the desired unit of weight;

An upper spar cap 16 which is a piece of the spar that takes most of the compressive load;

A lower spar cap 17 which is a piece of the spar that takes most of the tensile load;

A spar web 18 which is a flat shear web that transfers the compressive and tensile loads between the spar caps;

Spar load input 19 which is a reading of the upward force the wing is producing; and

Horizontal stabilizer brace 20 which is a structural member of the horizontal stabilizer that can be monitored.

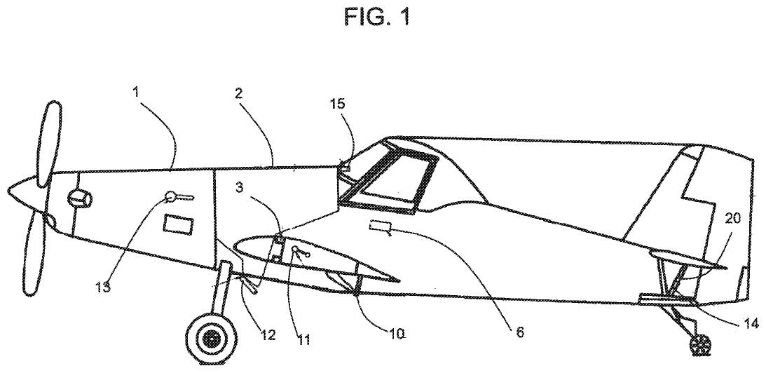

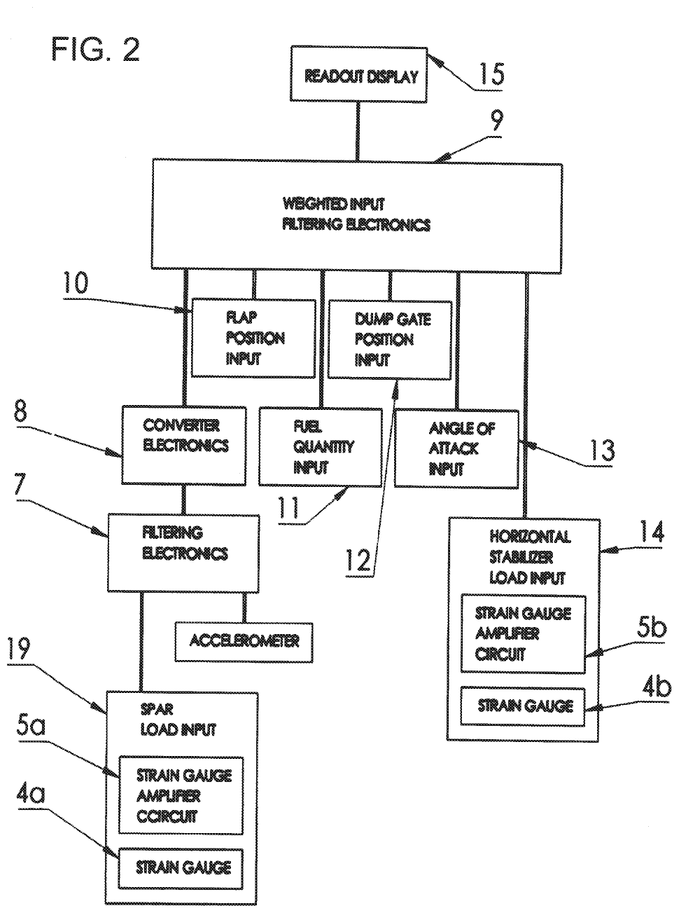

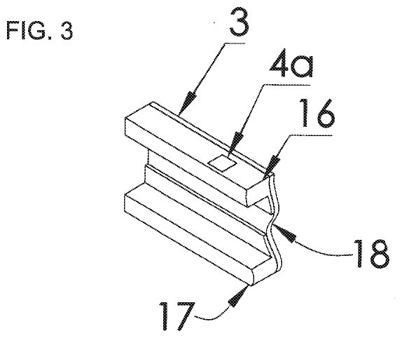

Referring to FIG. 1, FIG. 2 and FIG. 3 for the relationship between the components of the system disclosed herein according to the present invention. FIG. 1 illustrates a crop duster airplane 1, having a payload hopper 2, normally in the fuselage over the spar. The airplane has a structure that exhibits strain during flight 3, such as the main spar. The spar is designed with an upper spar cap 16 and lower spar cap 17 which is connected by the spar web 18 (as shown in FIG. 2). The strain gauge 4a is mounted on the upper spar cap 16 in an optimal direction to get maximum readout of varied hopper loads. Referring to FIG. 3, the strain gauge amplifier 5a is connected to the strain gauge 4a with the shortest connection possible, as the unamplified signal is very prone to external noise. The combination of the strain gauge on the spar and amplifier create the spar load input 19. The accelerometer 6 is mounted near the crop duster airplane's 1 center of gravity and must be aligned with the airplane. The spar load input 19 and accelerometer input are transferred through a set of filtering electronics 7 where they are combined and sent to the converter electronics 8. A secondary strain gauge 4b is mounted on the horizontal stabilizer brace 20 in an optimal direction to get maximum readout of varied downforce loads. A strain gauge amplifier 5b is connected to the strain gauge 4b with the shortest connection possible. The combination of the strain gauge on the horizontal stabilizer brace and the strain gauge amplifier create the horizontal stabilizer load input 14. The weighted input filtering electronics 9 compiles the data from the converting electronics 8, flap position input 10, fuel quantity input 11, dump gate position input 12, angle of attack input 13, and the horizontal stabilizer load input 14. A final reading from the weighted input filtering electronics 9 is sent to the readout display 15 in the cockpit for the pilot.

When the crop duster airplane 1 is in flight, the monitored structure 2, such as the spar, experiences a certain amount of strain. A strain gauge 4a is mounted to the upper spar cap 16. This strain is detected by the strain gauge 4a and the strain gauge amplifier 5a magnifies the strain signal resulting in the spar load input. The spar load input is proportional to both the hopper payload 2 and the g-load on the airplane sensed by the accelerometer 6. The filtering electronics 7 remove some high frequency noise and the g-load contribution from the input. The converter electronics 8 change the new input signal to a hopper weight estimate. This estimate is still too erratic and noisy to be useful because there are many inputs at any given time of flight that can change the weight estimate based upon the aircraft's orientation, fuel capacity, flap position, flight angle, etc. These inputs are taken into account in the weighted input filtering electronics 9, but first, each component needs to be accounted for individually.

It's important to determine flap position input 10 at any given time, because if the flaps are down, the bending moment on the wing is reduced because more of the aircraft's weight is supported on the inboard section of the wings. This correlates with a lower than expected weight estimate.

Another input that can produce error in a weight estimate is the fuel quantity input 11 which is constantly changing. The schematic shows the fuel inboard the wings. But the fuel can be in other locations on the aircraft and this is important because the fuel quantity needs to be converted into pounds and multiplied by a displacement factor. If the fuel is in the fuselage the displacement factor is 1. If the fuel is in tip tanks the value is negative. If the fuel is evenly spread though whole wing the factor is 0 and can be ignored. The calculated displacement value, in pounds, is subtracted from the weight estimate.

Another factor that can affect weight estimate is the dump gate position 12. When the dump gate position is closed, the weight in the hopper should not be changing. When the dump gate is open, the product will be released and the product weight in the hopper should be decreasing. The dump gate position input 12 can be used to estimate the rate of payload change. It is very beneficial to have an estimated rate of reduction when the gate is open. You can run a Kalman filter with the gate position driving the rate of reduction. This greatly helps reduce the lag in the filtering process.

The angle of attack input 13 and horizontal stabilizer inputs 14 are both linked. As the angle of attack changes, the center of pressure changes because the lift is being applied from the main wing. As the center of pressure moves, this changes the required down force created by the horizontal stabilizer. The horizontal stabilizer produces a flight load, not of actual weight but force from the air, which the strain gauge senses. The down force is used to balance the plane but is not an actual weight and needs to be subtracted out. The angle of attack can be sensed much quicker and more accurately than the horizontal stabilizer. So, it is beneficial to see the change in the angle of attack and anticipate the offset that will be needed to offset the horizontal stabilizer.

In the weighted input filtering electronics all these inputs have been applied to the weight estimate and a final filter removes any additional spikes resulting in the final readout display 15 weight estimate.

In one aspect, disclosed herein is a method for weighing payload in a flying aircraft.

According to some embodiments, the method for weighing payload in a flying crop duster aircraft 1 is comprised of the following steps:

Mount a strain gauge on the top of the upper spar cap. Prepare the spar surface, rough with 220 grit sand papers to remove dead paint, and then step to 400 grit, 600 grit, and final sand at 1000 grit. Clean the surface with 90% rubbing alcohol. Align the strain gauge square to the axis of the spar. Apply the strain gauge to the spar using thin CA glue, allow glue to dry, connect lead wires, and protect strain gauge with silicone. Connect lead wires to strain gauge amplifier. Check the amplifier for measurable output to ensure no damage occurred during installation. If there is a good signal, continue. If errored signal is found, repeat the strain gauge installation with new strain gauge. Repeat the strain gauge installation on the horizontal stabilizer brace structure. Align the strain gauge square to the axis of the horizontal brace. Protect the strain gauge with silicone and abrasion resistant tape. Mount the accelerometer near the main wing spar at the center of the aircraft. Check that the axes of the accelerometer are square to the axes of the airplane. A straightforward way to accomplish this is to mount the accelerometer flat on the spar web level to the horizontal axis of the plane. Mount the flap position input sensor next to the flap actuator; attach each end of the sensor to each end of the actuator. Check that the flap actuator runs through its full travel and the input readout is not maxed out. Connect fuel quantity input onto the aircrafts fuel gauges in cockpit. Mount the dump gate position input on the over center bell crank down at the dump gate. Move the dump gate through its full range of motion, check for a good clear output from the sensor, and ensure the sensor does not bind the gate system. Mount the angle of attack input on wing as instructed by manufacture. Mount the readout display in the cockpit in clear view of the pilot. Mount the remaining electronics in the cockpit out of the way of normal operation but still accessible by the pilot. Assemble the system on the aircraft as prescribed in the earlier sections. Make all required electrical connections and check for proper data transmission. Run test flights with the aircraft at 3 or more known payload weights. Be sure to have one flight with a full load and one flight with an empty load. The strain gauge readings from these flights will be used as calibration for the strain gauge to correlate to a payload weight. Additional test flights can be run for the additional inputs into the system to get proper filter variable weight coefficients. Once all data is collected for that model of aircraft, the data can be put into the filter. All pieces are necessary except the inputs: flap position, gate position, angle of attack, horizontal force, fuel quantity. Those inputs are optional. The more inputs, the better defined the model of the aircraft in flight, and the better approximation of the payload weight. A strain system on the aircraft's landing gear will give you the ability to have a payload weight before takeoff.

The inputs of the strain gauge and the accelerometer should be correlated to each other early in the data processing string. The excess strain induced by the airplane turns should be canceled out by the accelerometer data as soon as possible. The other optional inputs can be added in just about any order and produce a working weight estimate.

You would install all the components into your aircraft, connect all the components, and input the recorded variables from the flight test. Then the pilot could use the readout for an accurate onboard product weight.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A system for weighing payload in a flying aircraft, comprising: a first strain gauge mounted on an upper spar cap of the aircraft structure to determine a strain signal; a first strain gauge amplifier connected to the first strain gauge to magnify the strain signal resulting in a spar load input; an accelerometer mounted near the aircraft's center of gravity; filtering electronics removing noise and the g-load contribution from the spar load input and the accelerometer to generate a new input; converter electronics connected to the filtering electronics changing the new input to a payload weight estimate input; a weighted input filtering electronics which adjusts filtering values based on at least one input to produce the payload weight; and a readout display device for showing the pilot the payload weight in the hopper; wherein the first strain gauge amplifier is connected to the first strain gauge with the shortest connection possible.

2. The system of claim 1 further comprising a second strain gauge mounted on a horizontal stabilizer bracer; a second strain gauge amplifier connected to the second strain gauge to magnify the strain signal resulting in a horizontal stabilizer load input which is a reading of the downward force the tail is providing to the plane; wherein the second strain gauge amplifier is connected to the second strain gauge with the shortest connection possible.

3. The system of claim 1 further comprising at least one of the following components: a component to determine flap position input; a component to determine fuel quantity input; a component to determine dump gate position input; and a component to determine angle of attack input.

4. The system of claim 2, wherein the upper spar cap is connected to a lower spar cap through a spar web; the upper spar cap is a piece of a spar that takes most of the compressive load; the lower spar cap is a piece of the spar that takes most of the tensile load; the spar web is a flat shear web that transfer the compressive and tensile loads between the spar caps; and the spar load input is a reading of the upward force the wing is producing; the horizontal stabilizer brace is a structural member of the horizontal stabilizer that can be monitored.

5. The system of claim 1, wherein the first strain gauge is mounted on the upper spar cap of the aircraft structure in an appropriate direction to get maximum readout variation with different hopper payloads.

6. The system of claim 1, wherein the accelerometer is mounted near the aircraft's center of gravity and must be aligned with the airplane.

7. The system of claim 1, wherein the spar load input is proportional to both the hopper payload and the g-load on the aircraft sensed by the accelerometer.

8. The system of claim 3, wherein the flap position input is a continuous or binary reading that is derived from a potentiometer; the fuel quantity input is a reading of the quantity of fuel onboard; the dump gate position input is a continuous or binary reading that is derived from a potentiometer; the angle of attack input is a reading of the angle of attack of the flying plane; wherein the weighted input filtering electronics compiles the payload weight estimate input from the converter electronics, the flap position input, the fuel quantity input, the dump gate position input, the angle of attack input, and the horizontal stabilizer load input and sends a final reading of the payload weight to the readout display in the cockpit for the pilot.

9. A method for use in measuring the payload weight in real-time in a flying aircraft, comprising the steps of:
mounting a first strain gauge on the top of the upper spar cap of the aircraft such that the strain gauge's axis is aligned to the axis of the spar and connecting the first strain gauge to a first strain gauge amplifier using lead wires for providing a spar load input;
mounting an accelerometer near the main wing spar at the center of the aircraft such that the axes of the accelerometer are square to the axes of the aircraft for providing accelerometer input;
mounting a readout display in the cockpit in clear view of the pilot; and
mounting remaining electronics including filtering electronics, converter electronics, and weighted input filtering electronics;
wherein the readout display receives a final payload weight reading from the weighted input filtering electronics and shows it to the pilot.

10. The method of claim 9, wherein the filtering electronics removes noise and g-load contribution from the spar load input to generate filtered spar load input; the converter electronics map or convert the filtered spar load input into a weight reading; and the weighted input filtering electronics compiles the data from the converting electronics, produce a final payload weight reading, and send to the readout display in the cockpit for the pilot.

11. The method of claim 10, further comprising at least one of the steps of:
mounting a second strain gauge on the horizontal stabilizer brace structure such that the strain gauge's axis is aligned to the axis of the horizontal brace and connecting the second strain gauge with a second strain gauge amplifier with lead wires for providing horizontal force (horizontal stabilizer load input);
mounting a flap position input sensor next to the flap actuator for providing flap position input;
connecting fuel quantity input onto the aircrafts fuel gauges in cockpit for providing fuel quantity input;
mounting a dump gate position input sensor on the over center bell crank down at the dump gate for providing dump gate position input;
mounting an angle of attack input sensor on the wing for providing angle of attack input;
mounting a set of weighted input filtering electronics;
wherein the set of weighted input filtering electronics compiles the data from the converting electronics, flap position input, fuel quantity input, dump gate position input, angle of attack input, and the horizontal stabilizer load input, and send a final payload weight reading to the readout display in the cockpit for the pilot.

12. The method of claim 11, further comprising the steps of:
running test flights with the known payload weights;
calibrating the strain gauge to correlate to a payload weight; and
collecting data and putting data into filter.
